(19) United States
(12) Patent Application Publication
(10) Pub. No.: US 2026/0064611 A1
(43) Pub. Date: Mar. 5, 2026

(54) PROCESSING-IN-MEMORY DEVICE AND PROCESSING-IN-MEMORY PACKAGE WITH ASYMMETRIC INTERNAL AND EXTERNAL BANDWIDTH

(71) Applicant: SK hynix Inc., Icheon-si Gyeonggi-do (KR)

(72) Inventor: Seong Ju LEE, San Jose, CA (US)

(73) Assignee: SK hynix Inc., Icheon-si Gyeonggi-do (KR)

(21) Appl. No.: 19/301,333

(22) Filed: Aug. 15, 2025

Related U.S. Application Data
(60) Provisional application No. 63/687,917, filed on Aug. 28, 2024.

(30) Foreign Application Priority Data
Jul. 3, 2025 (KR) 10-2025-0089600

(51) Int. Cl. G06F 13/20; G06F 7/50; G06F 7/523

(52) U.S. Cl. CPC G06F 13/20; G06F 7/50; G06F 7/523; G06F 2213/0062

(57) ABSTRACT

A processing-in-memory (PIM) device includes a processing unit die configured to communicate with an external device with an external bandwidth, and a memory die configured to communicate with the processing unit die with an internal bandwidth. The external bandwidth and the internal bandwidth are asymmetrically configured to operate at different data transfer rates.

### CROSS-REFERENCE TO RELATED APPLICATION

The present application claims priority under 35 U.S.C § 119 (e) to U.S. Patent application No. 63/687,917 filed on Aug. 28, 2024, and under 35 U.S.C. § 119 (a) to Korean application number 10-2025-0089600 filed on Jul. 3, 2025, in the Korean Intellectual Property Office, the entire contents of which applications are incorporated herein by reference.

### BACKGROUND

### 1. Technical Field

Various embodiments of the present disclosure relate to processing-in-memory (PIM) devices, and more particularly, to PIM devices and PIM packages having asymmetric internal and external bandwidths.

### 2. Related Art

Recently, neural network algorithms have demonstrated remarkable performance improvements across various fields, including image recognition, speech recognition, and natural language processing. It is anticipated that neural network algorithms will be actively utilized in a wide range of applications such as factory automation, medical services, and autonomous driving vehicles. As such, the development of various hardware architectures capable of efficiently processing these algorithms is being actively pursued.

A neural network algorithm is a learning algorithm modeled after biological neural networks. Among recent developments, deep neural networks (DNNs), which are a type of multi-layer perceptron (MLP) composed of more than eight layers, have been extensively studied. At present, most neural network operations are performed using graphics processing units (GPUs). GPUs are known to be efficient for handling repetitive and highly parallel operations due to their large number of cores.

However, in the case of DNNs—which are actively researched and may include, for example, more than one million neurons—the amount of computation required is enormous. Accordingly, there is a growing demand for the development of hardware accelerators optimized for neural network operations involving such large-scale computational loads.

### SUMMARY

A PIM device may include a processing unit die configured to communicate with an external device with an external bandwidth, and a memory die configured to communicate with the processing unit die with an internal bandwidth. The external bandwidth and the internal bandwidth are asymmetrically configured to operate at different data transfer rates.

A PIM package may include a package substrate, at least one PIM device disposed on the package substrate, and a molding compound covering the at least one PIM device on the package substrate. The at least one PIM device may include a processing unit die configured to communicate with an external device with an external bandwidth, and a memory die configured to communicate with the processing unit die with an internal bandwidth. The external bandwidth and the internal bandwidth are asymmetrically configured to operate at different data transfer rates.

### BRIEF DESCRIPTION OF THE DRAWINGS

FIG. 1 is a perspective view illustrating an example of a PIM device according to an embodiment of the present disclosure.

FIG. 2 is a diagram illustrating an example layout structure of a processing unit die included in the PIM device of FIG. 1.

FIG. 3 is a circuit diagram illustrating an example of signal selection logic included in the processing unit die of FIG. 2.

FIG. 4 is a cross-sectional view illustrating an example of the structure of the PIM device of FIG. 1.

FIG. 5 is an enlarged cross-sectional view showing an edge portion of the PIM device depicted in FIG. 4.

FIG. 6 is a diagram illustrating an example configuration of a memory die included in the PIM device according to the present disclosure.

FIG. 7 is a diagram illustrating another example configuration of a memory die included in the PIM device according to the present disclosure.

FIG. 8 is a diagram illustrating another example configuration of a memory die included in the PIM device according to the present disclosure.

FIG. 9 is a diagram illustrating an example configuration of a processing unit region of a processing unit die included in the PIM device according to the present disclosure.

FIG. 10 is a cross-sectional view illustrating another example of a processing-in-memory (PIM) device according to the present disclosure.

FIG. 11 is a cross-sectional view illustrating an example of a PIM package according to the present disclosure.

### DETAILED DESCRIPTION

Terms such as “first” and “second” are used to distinguish between various elements and do not imply size, order, priority, quantity, or importance of the elements. For example, a first element may be referred to as a second element in one example, and the second element may be referred to as a first element in another example.

When an element is referred to as “connected” or “coupled” to another element, the elements may be connected directly or through one or more intervening elements between the elements. When two elements are referred to as “directly connected” or “directly coupled,” one element is directly connected or directly coupled to the other element without an intervening element between the two elements.

Terms such as “over,” “on,” “inside,” “higher,” “high,” “low,” “left,” “right,” “column,” “row,” “level,” and other terms implying relative spatial relationship or orientation are utilized only for the purpose of ease of description or reference to a drawing and are not otherwise limiting.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

It should be understood that the various embodiments described below take DRAM as an example as a memory device, but are not limited thereto. For example, the same may be applied to static random access memory (SRAM), synchronous DRAM (SDRAM), double data rate synchronous DRAM (DDR SDRAM, DDR2 SDRAM, DDR3 SDRAM, etc.), graphics double data rate synchronous DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data output DRAM (EDO DRAM), burst EDO DRAM (BEDO DRAM), multibank DRAM (MDRAM), synchronous graphics RAM (SGRAM), and/or other various forms of DRAM.

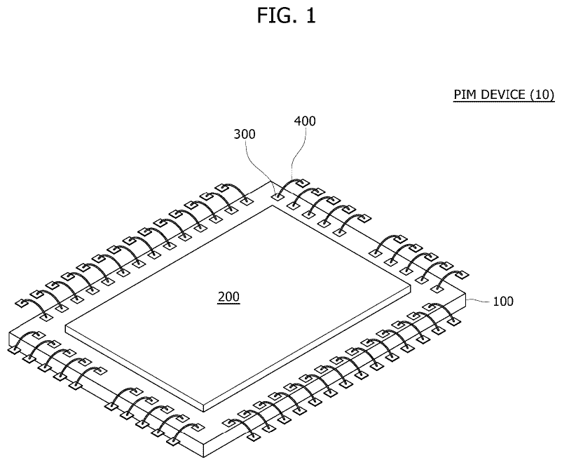

FIG. 1 is a perspective view illustrating an example of a PIM device according to an embodiment of the present disclosure.

Referring to FIG. 1, a PIM device 10 includes a processing unit die 100 and a memory die 200. The processing unit die 100 and the memory die 200 may be manufactured as separate dies and then combined together. In one embodiment, the memory die 200 is disposed on an upper surface of the processing unit die 100. The memory die 200 may have a smaller cross-sectional area than the processing unit die 100. The upper surfaces adjacent to the four sides of the processing unit die 100 are exposed by the memory die 200. On the exposed upper surfaces of the processing unit die 100, a plurality of pads 300 are arranged at regular intervals. The plurality of pads 300 may be coupled to ends of wires 400 for electrical connection with external devices. Although not shown in the drawings, the processing unit die 100 and the memory die 200 may be electrically interconnected via bumps, such as micro bumps.

Data communication between the PIM device 10 and an external device, such as a host or a controller, is performed through the wires 400 that are coupled to the processing unit die 100 and used for data input/output. Data communication between the processing unit die 100 and the memory die 200 of the PIM device 10 is carried out through the micro bumps. The processing unit die 100 may receive data from the external device and transmit the data to the memory die 200 through the micro bumps. The memory die 200 may transmit stored data to the processing unit die 100 for use in computation performed by the processing unit die 100. The processing unit die 100 may transmit result data, generated from computations, to the external device. In one embodiment, to perform parallel operations in the processing unit die 100, data transmission between the processing unit die 100 and the memory die 200 may be implemented through a parallel-based signaling scheme.

The wires 400 used for data communication between the processing unit die 100 of the PIM device 10 and the external device have an external bandwidth of a first bandwidth. In contrast, the micro bumps used for data communication between the processing unit die 100 and the memory die 200 of the PIM device 10 have an internal bandwidth of a second bandwidth, the second bandwidth being greater than the first bandwidth. That is, the amount of data that can be transmitted per unit time between the processing unit die 100 and the memory die 200 of the PIM device 10 is greater than the amount of data that can be transmitted per unit time between the PIM device 10 and the external device.

Because the data output from the processing unit die 100 to the external device corresponds to result data from computations performed by the processing unit die 100, the external bandwidth of the PIM device 10 is lower than the internal bandwidth. On the other hand, because the computational speed of the processing unit die 100 may be determined by the amount of data transmitted from the memory die 200 to the processing unit die 100, the internal bandwidth of the PIM device 10 is higher than the external bandwidth. In one example, the internal bandwidth and the external bandwidth of the PIM device 10 may be 512 GB/s and 18.2 GB/s, respectively.

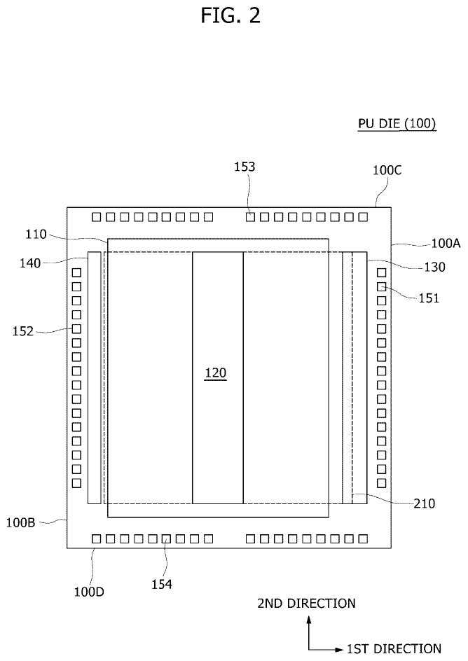

FIG. 2 is a diagram illustrating an example layout structure of a processing unit die included in the PIM device of FIG. 1.

Referring to FIG. 2, a processing unit die 100 includes a processing unit region 110 in which processing unit circuits are disposed, an input/output region 120 in which micro bumps are arranged, an interface region 130 in which interface circuits are arranged, and a test region 140 in which test circuits are arranged. A dashed box 210 in FIG. 2 represents a region in which the processing unit die 100 overlaps with the memory die 200 of FIG. 1.

In one embodiment, the processing unit die 100 may have four sides 100A, 100B, 100C, and 100D. A first side 100A of the processing unit die 100 is exposed in a first direction, which corresponds to the right side as shown in FIG. 2. A second side 100B is exposed in an opposite direction to the first side 100A, such as the left side. A third side 100C is exposed in a second direction, which corresponds to the top side as shown in FIG. 2. A fourth side 100D is exposed in an opposite direction to the third side 100C, such as the bottom side. The terminology used for the different sides is merely an example that may vary based on orientation.

The processing unit region 110 may be located at a central area of the processing unit die 100. Processing unit circuits may be disposed within the processing unit region 110. The processing unit circuits may include a plurality of arithmetic circuits, such as multiply-and-accumulate (MAC) circuits. The processing unit circuits may also include a register circuit for storing operand data. Further, the processing unit circuits may include a control circuit that controls the plurality of arithmetic circuits and the register circuit.

A plurality of interconnections for signal transmission may be disposed in the processing unit region 110. The plurality of interconnections may include data input/output lines coupled to the micro bumps disposed in the input/output region 120, signal transmission lines coupled to a group of wires through the interface region 130, and signal transmission lines coupled to another group of wires through the test region 140.

Arithmetic circuits disposed in the processing unit region 110 may receive first operand data provided from the memory die 200 of FIG. 1 through micro bumps disposed in the input/output region 120. Additionally, the arithmetic circuits may receive second operand data provided from a register circuit disposed in the processing unit region 110 via data transmission lines also disposed within the processing unit region 110. The arithmetic circuits may perform operations using the first operand data and the second operand data to generate result data. The arithmetic circuits may provide the result data to the memory die 200 of FIG. 1 through the micro bumps disposed in the input/output region 120 or may provide the result data to a device external to the processing unit die 100 through the interface region 130 and the wires.

The input/output region 120 may be disposed over the processing unit region 110 to overlap with the processing unit region 110. The input/output region 120 may include interconnectors, such as micro bumps, that provide physical and electrical connections to the memory die 200 of FIG. 1. The plurality of arithmetic circuits, register files, and control circuits disposed in the processing unit region 110 of the processing unit die 100 may exchange data and signals with the memory die 200 of FIG. 1 through the micro bumps.

The interface region 130 may be disposed adjacent to one side of the processing unit region 110. As illustrated in FIG. 2, the interface region 130 is disposed adjacent to a side of the processing unit region 110 that is near the first side 100A. A plurality of interface circuits may be disposed within the interface region 130. In one embodiment, the plurality of interface circuits may include a command/address decoder, a physical layer circuit, a serializer/deserializer (SerDes) circuit, a protocol controller, buffer and queue management circuits, voltage level shifters, clock domain crossing (CDC) circuits, and error detection and correction circuits.

The test region 140 may be disposed adjacent to a side of the processing unit region 110 that is near the second side 100B. A plurality of test circuits may be disposed within the test region 140. In one embodiment, the plurality of test circuits may include built-in self-test (BIST) circuits, scan chain circuits, boundary scan (JTAG) circuits, design-for-test (DFT) control circuits, built-in current sensors (BICS), and delay fault detection circuits.

A plurality of pads may be disposed on the edge of an upper surface of the processing unit die 100. First pads 151 for transmitting data, clock signals, command signals, address signals, and power signals may be disposed on the edge of the upper surface between the interface region 130 and the first side 100A of the processing unit die 100. Second pads 152 for test and power signals may be disposed on the edge of the upper surface between the test region 140 and the second side 100B of the processing unit die 100.

In one embodiment, the second pads 152 may include direct access (DA) pads that directly access the memory die 200 of FIG. 1 through the micro bumps disposed in the input/output region 120, without passing through the interface circuits in the interface region 130. The DA pads may be coupled to signal selection logic disposed within the processing unit region 110.

Third pads 153 and fourth pads 154 for power delivery may be disposed on the edge of the upper surface between the top of the processing unit region 110 and the third side 100C and may be disposed between the bottom of the processing unit region 110 and the fourth side 100D, respectively. As described with reference to FIG. 1, the first pads 151, second pads 152, third pads 153, and fourth pads 154 may be coupled to the wires 400 of FIG. 1.

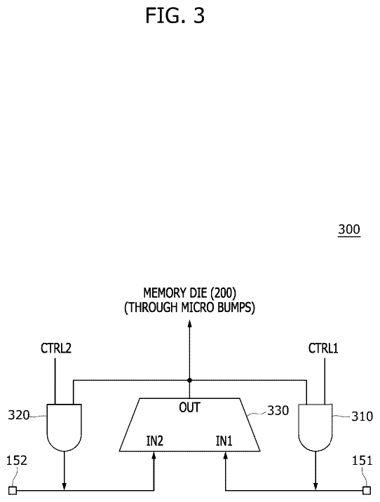

FIG. 3 is a circuit diagram illustrating an example of signal selection logic included in the processing unit die of FIG. 2.

Referring to FIG. 3, signal selection logic 300 is configured to selectively transmit either a first signal, received via a first pad 151, or a second signal, received via a second pad 152, to the memory die 200. In this example, the second pad 152 may be a direct access (DA) pad. In such case, data transmitted from an external device of the PIM device 10 may be directly transferred to the memory die 200 of FIG. 1 without passing through the interface circuits included in the interface region 130 of FIG. 2.

The signal selection logic 300 may include a first AND gate 310, a second AND gate 320, and a multiplexer 330. The first AND gate 310 has a first input terminal, a second input terminal, and an output terminal. A first control signal CTRL1 is input to the first input terminal of the first AND gate 310. The second input terminal of the first AND gate 310 is coupled to an output terminal OUT of the multiplexer 330. The output terminal of the first AND gate 310 is connected to wiring between the first pad 151 and a first input terminal IN1 of the multiplexer 330.

The second AND gate 320 has a first input terminal, a second input terminal, and an output terminal. A second control signal CTRL2 is input to the first input terminal of the second AND gate 320. The second input terminal of the second AND gate 320 is coupled to the output terminal OUT of the multiplexer 330. The output terminal of the second AND gate 320 is connected to wiring between the second pad 152 and a second input terminal IN2 of the multiplexer 330.

The multiplexer 330 includes a first input terminal IN1, a second input terminal IN2, and an output terminal OUT. The first input terminal IN1 of the multiplexer 330 is coupled to the first pad 151 and the output terminal of the first AND gate 310. The second input terminal IN2 of the multiplexer 330 is coupled to the second pad 152 and the output terminal of the second AND gate 320. The output terminal OUT of the multiplexer 330 is coupled to the memory die 200 through a micro bump.

In one embodiment, the output terminal OUT of the multiplexer 330 may be connected to a global input/output (GIO) line of the memory die 200. The output terminal OUT of the multiplexer 330 is also coupled to the second input terminals of the first AND gate 310 and the second AND gate 320.

The signal selection logic 300 selectively transmits one of the first signal and the second signal to the memory die 200, based on the first control signal CTRL1 and the second control signal CTRL2. When the first control signal CTRL1 is at a high level and the second control signal CTRL2 is at a low level, the first AND gate 310 is activated while the second AND gate 320 is deactivated. As the first AND gate 310 is activated and the second AND gate 320 is deactivated, the signal transmitted via the first pad 151 is sent to the memory die 200 through the multiplexer 330.

Conversely, when the first control signal CTRL1 is at a low level and the second control signal CTRL2 is at a high level, the second AND gate 320 is activated while the first AND gate 310 is deactivated. As the second AND gate 320 is activated and the first AND gate 310 is deactivated, the signal transmitted via the second pad 152, i.e., the DA pad, is delivered to the memory die 200 through the multiplexer 330.

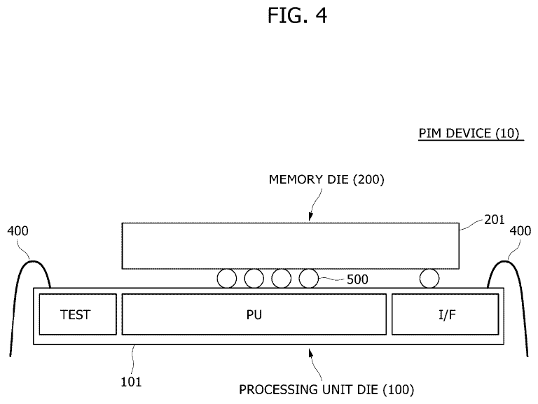

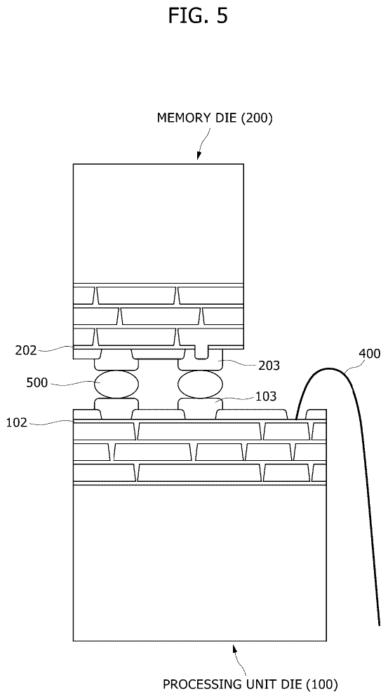

FIG. 4 is a cross-sectional view illustrating an example of the structure of the PIM device of FIG. 1. And FIG. 5 is an enlarged cross-sectional view showing an edge portion of the PIM device depicted in FIG. 4.

Referring first to FIG. 4, the PIM device 10 includes a processing unit die 100 disposed on a lower side and a memory die 200 disposed on an upper side. The processing unit die 100 and the memory die 200 may be electrically coupled via micro bumps 500. As described with reference to FIG. 2, the micro bumps 500 are arranged in the input/output region (120 in FIG. 2) of the processing unit die 100. In this example, additional micro bumps may also be disposed over the interface region I/F, although such an arrangement is merely optional.

The processing unit die 100 includes a processing unit region PU, an interface region I/F, and a test region TEST. The processing unit region 110, interface region 130, and test region 140 described with reference to FIG. 2 respectively correspond to the PU, I/F, and TEST regions shown in FIG. 4. The memory die 200 may include a plurality of memory cells. The plurality of memory cells may be divided into a plurality of memory banks.

The edge of an upper surface of the processing unit die 100 is bonded to one end of a wire 400. Although not shown in the drawings, the other end of the wire 400 may be bonded to a printed circuit substrate (PCB) or a main board. Accordingly, the processing unit die 100 transmits signals to and from external devices, such as a host or a controller, that are connected to the main board via the wire 400. Additionally, the processing unit die 100 communicates with the memory die 200 via the micro bumps 500.

As described with reference to FIG. 1, because the external bandwidth of the PIM device 10 is relatively smaller than the internal bandwidth, a large number of input/output terminals are not required for communication between the PIM device 10 and the external device. Therefore, by implementing the electrical connection between the processing unit die 100 and the main board using the wires 400, the manufacturing complexity and cost of the PIM device 10 can be reduced. Furthermore, because both the wires 400 and the micro bumps 500 are arranged on the upper surface of the processing unit die 100, high-cost and high-complexity structures such as through-silicon vias (TSVs) are unnecessary.

Referring now to FIG. 5 for a more detailed explanation, upper portions of the processing unit die 100 include first metal wiring layers 102. The first metal wiring layers 102 may have a multilayer structure. Some surface areas of the uppermost first metal wiring layer, among the first metal wiring layers 102, are exposed at the upper surface of the processing unit die 100. Portions of the exposed surfaces of the first metal wiring layers 102 are bonded to first bump pads 103, which are coupled to the lower surfaces of the micro bumps 500. Other portions of the exposed surfaces of the first metal wiring layers 102 form the pads 151, 152, 153, and 154, described with reference to FIG. 2. Accordingly, these other portions are also connected to one end of the wires 400.

At the lower side of the memory die 200, second metal wiring layers 202 are formed. The second metal wiring layers 202 may also have a multilayer structure. Some surface areas of the lowermost second metal wiring layer, among the second metal wiring layers 202, are exposed at the lower surface of the memory die 200. Portions of the exposed surfaces of the second metal wiring layers 202 are bonded to second bump pads 203, which are coupled to the upper surfaces of the micro bumps 500.

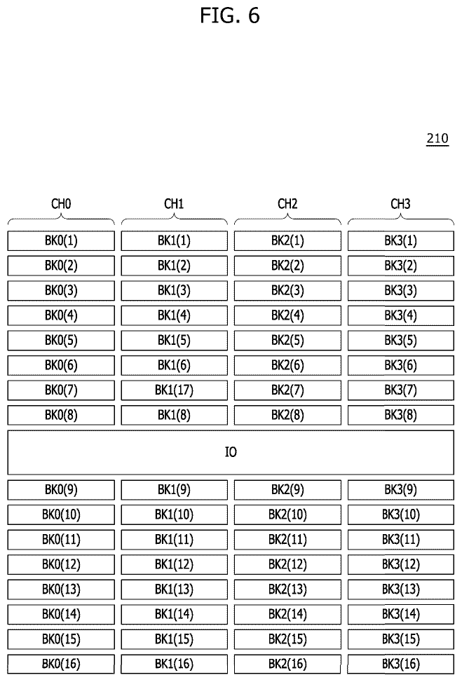

FIG. 6 is a diagram illustrating an example configuration of a memory die included in the PIM device according to the present disclosure.

Referring to FIG. 6, a memory die 210 includes a plurality of memory banks connected to a plurality of channels and includes an input/output region IO. In the following example, it is assumed that the memory die 210 includes sixty-four memory banks and that these sixty-four memory banks are connected to first to fourth channels CH0-CH3. Although not shown in the drawings, each of the memory banks may include a plurality of mats. Each of the mats may have a cell array structure.

In one example, four of the sixty-four memory banks may form a single memory bank group. Each of the first to fourth channels CH0 to CH3 may be coupled to sixteen memory banks. As shown in FIG. 6, the first channel CH0 is coupled to first to sixteenth memory banks BK0(1)-BK0(16). The second channel CH1 is coupled to memory banks BK1(1)-BK1(16). The third channel CH2 is coupled to memory banks BK2(1)-BK2(16). And the fourth channel CH3 is coupled to memory banks BK3(1)-BK3(16). Each of the channels CH0 to CH3 may operate independently.

The first to eighth memory banks BK0(1)-BK0(8), BK1(1)-BK1(8), BK2(1)-BK2(8), and BK3(1)-BK3(8), connected to the respective first to fourth channels CH0-CH3, may be disposed above the input/output region IO. The ninth to sixteenth memory banks BK0(9)-BK0(16), BK1(9)-BK1(16), BK2(9)-BK2(16), and BK3(9)-BK3(16), connected to the respective channels CH0-CH3, may be disposed below the input/output region IO.

The memory banks connected to each channel share the input/output region IO. Specifically, the first to sixteenth memory banks BK0(1)-BK0(16) connected to channel CH0 share the IO region. Likewise, the memory banks BK1(1)-BK1(16), BK2(1)-BK2(16), and BK3(1)-BK3(16), connected to channels CH1, CH2, and CH3 respectively, also share the IO region.

Among the first to sixteenth memory banks connected to each channel, one memory bank is selected by a bank address and accessed through the input/output region IO. For example, one memory bank from BK0(1) to BK0(16) connected to channel CH0 is selected by a bank address and accessed via the IO region. Similarly, one memory bank from BK1(1) to BK1(16), BK2(1) to BK2(16), or BK3(1) to BK3(16) is selected by a bank address and accessed through the IO region.

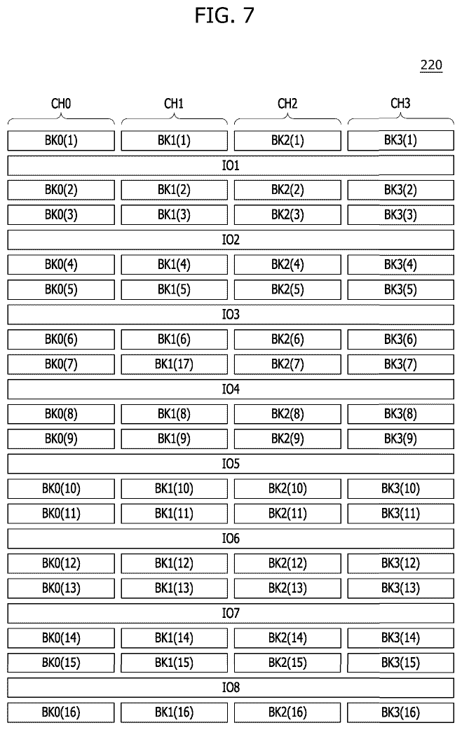

FIG. 7 is a diagram illustrating another example configuration of a memory die included in the PIM device according to the present disclosure.

Referring to FIG. 7, a memory die 220 includes a plurality of memory banks connected to a plurality of channels, and a plurality of input/output regions. In this example, it is assumed that the memory die 220 includes sixty-four memory banks, and that the sixty-four memory banks are connected to first to fourth channels CH0-CH3. Although not shown in the drawings, each of the memory banks may include a plurality of mats. Each of the mats may have a cell array structure.

Each of the channels CH0 to CH3 may be connected to sixteen memory banks. As shown in FIG. 7, the first channel CH0 is connected to memory banks BK0(1) to BK0(16). The second channel CH1 is connected to memory banks BK1(1) to BK1(16). The third channel CH2 is connected to memory banks BK2(1) to BK2(16). And the fourth channel CH3 is connected to memory banks BK3(1) to BK3(16). Each of the channels CH0 to CH3 may operate independently.

The memory die 220 includes first to eighth input/output regions IO1-IO8. Through the input/output regions IO1 to IO8, the memory die 220 may exchange data and signals with the processing unit die 100 of FIG. 1. In one embodiment, in each of the channels CH0 to CH3, two memory banks may form a pair. Each pair of memory banks is arranged to share one of the input/output regions.

A first input/output region IO1 is disposed between first memory banks BK0(1), BK1(1), BK2(1), and BK3(1) and second memory banks BK0(2), BK1(2), BK2(2), and BK3(2), respectively connected to the first to fourth channels CH0-CH3. In the first channel CH0, the first memory bank BK0(1) and the second memory bank BK0(2) form a memory bank pair that shares the first input/output region IO1. In the second channel CH1, the first memory bank BK1(1) and the second memory bank BK1(2) form a memory bank pair that shares the first input/output region IO1. In the third channel CH2, the first memory bank BK2(1) and the second memory bank BK2(2) form a memory bank pair that shares the first input/output region IO1. In the fourth channel CH3, the first memory bank BK3(1) and the second memory bank BK3(2) form a memory bank pair that shares the first input/output region IO1.

A second input/output region IO2 is disposed between third memory banks BK0(3), BK1(3), BK2(3), and BK3(3) and fourth memory banks BK0(4), BK1(4), BK2(4), and BK3(4) respectively connected to the first to fourth channels CH0-CH3. In the first channel CH0, the third memory bank BK0(3) and the fourth memory bank BK0(4) form a memory bank pair that shares the second input/output region 102. In the second channel CH1, the third memory bank BK1(3) and the fourth memory bank BK1(4) form a memory bank pair that shares the second input/output region 102. In the third channel CH2, the third memory bank BK2(3) and the fourth memory bank BK2(4) form a memory bank pair that shares the second input/output region 102. In the fourth channel CH3, the third memory bank BK3(3) and the fourth memory bank BK3(4) form a memory bank pair that shares the second input/output region IO2.

A third input/output region 103 is disposed between fifth memory banks BK0(5), BK1(5), BK2(5), and BK3(5) and sixth memory banks BK0(6), BK1(6), BK2(6), and BK3(6), respectively connected to the first through fourth channels CH0-CH3. In the first channel CH0, the fifth memory bank BK0(5) and the sixth memory bank BK0(6) form a memory bank pair that shares the third input/output region IO3. In the second channel CH1, the fifth memory bank BK1(5) and the sixth memory bank BK1(6) form a memory bank pair that shares the third input/output region IO3. In the third channel CH2, the fifth memory bank BK2(5) and the sixth memory bank BK2(6) form a memory bank pair that shares the third input/output region IO3. In the fourth channel CH3, the fifth memory bank BK3(5) and the sixth memory bank BK3(6) form a memory bank pair that shares the third input/output region IO3.

A fourth input/output region IO4 is disposed between seventh memory banks BK0(7), BK1(7), BK2(7), and BK3(7) and eighth memory banks BK0(8), BK1(8), BK2(8), and BK3(8), respectively connected to the first through fourth channels CH0-CH3. In the first channel CH0, the seventh memory bank BK0(7) and the eighth memory bank BK0(8) form a memory bank pair that shares the fourth input/output region IO4. In the second channel CH1, the seventh memory bank BK1(7) and the eighth memory bank BK1(8) form a memory bank pair that shares the fourth input/output region IO4. In the third channel CH2, the seventh memory bank BK2(7) and the eighth memory bank BK2(8) form a memory bank pair that shares the fourth input/output region IO4. In the fourth channel CH3, the seventh memory bank BK3(7) and the eighth memory bank BK3(8) form a memory bank pair that shares the fourth input/output region IO4.

A fifth input/output region 105 is disposed between ninth memory banks BK0(9), BK1(9), BK2(9), and BK3(9) and tenth memory banks BK0(10), BK1(10), BK2(10), and BK3(10), respectively connected to the first through fourth channels CH0-CH3. In the first channel CH0, the ninth memory bank BK0(9) and the tenth memory bank BK0(10) form a memory bank pair that shares the fifth input/output region 105. In the second channel CH1, the ninth memory bank BK1(9) and the tenth memory bank BK1(10) form a memory bank pair that shares the fifth input/output region 105. In the third channel CH2, the ninth memory bank BK2(9) and the tenth memory bank BK2(10) form a memory bank pair that shares the fifth input/output region 105. In the fourth channel CH3, the ninth memory bank BK3(9) and the tenth memory bank BK3(10) form a memory bank pair that shares the fifth input/output region IO5.

A sixth input/output region 106 is disposed between eleventh memory banks BK0(11), BK1(11), BK2(11), and BK3(11) and twelfth memory banks BK0(12), BK1(12), BK2(12), and BK3(12), respectively connected to the first through fourth channels CH0-CH3. In the first channel CH0, the eleventh memory bank BK0(11) and the twelfth memory bank BK0(12) form a memory bank pair that shares the sixth input/output region 106. In the second channel CH1, the eleventh memory bank BK1(11) and the twelfth memory bank BK1(12) form a memory bank pair that shares the sixth input/output region 106. In the third channel CH2, the eleventh memory bank BK2(11) and the twelfth memory bank BK2(12) form a memory bank pair that shares the sixth input/output region IO6. In the fourth channel CH3, the eleventh memory bank BK3(11) and the twelfth memory bank BK3(12) form a memory bank pair that shares the sixth input/output region IO6.

A seventh input/output region 107 is disposed between thirteenth memory banks BK0(13), BK1(13), BK2(13), and BK3(13) and fourteenth memory banks BK0(14), BK1(14), BK2(14), and BK3(14), respectively connected to the first through fourth channels CH0-CH3. In the first channel CH0, the thirteenth memory bank BK0(13) and the fourteenth memory bank BK0(14) form a memory bank pair that shares the seventh input/output region 107. In the second channel CH1, the thirteenth memory bank BK1(13) and the fourteenth memory bank BK1(14) form a memory bank pair that shares the seventh input/output region 107. In the third channel CH2, the thirteenth memory bank BK2(13) and the fourteenth memory bank BK2(14) form a memory bank pair that shares the seventh input/output region 107. In the fourth channel CH3, the thirteenth memory bank BK3(13) and the fourteenth memory bank BK3(14) form a memory bank pair that shares the seventh input/output region IO7.

An eighth input/output region IO8 is disposed between fifteenth memory banks BK0(15), BK1(15), BK2(15), and BK3(15) and sixteenth memory banks BK0(16), BK1(16), BK2(16), and BK3(16), respectively connected to the first through fourth channels CH0-CH3. In the first channel CH0, the fifteenth memory bank BK0(15) and the sixteenth memory bank BK0(16) form a memory bank pair that shares the eighth input/output region IO8. In the second channel CH1, the fifteenth memory bank BK1(15) and the sixteenth memory bank BK1(16) form a memory bank pair that shares the eighth input/output region IO8. In the third channel CH2, the fifteenth memory bank BK2(15) and the sixteenth memory bank BK2(16) form a memory bank pair that shares the eighth input/output region IO8. In the fourth channel CH3, the fifteenth memory bank BK3(15) and the sixteenth memory bank BK3(16) form a memory bank pair that shares the eighth input/output region IO8.

In each of the first through fourth channels CH0-CH3, a memory bank pair may input or output data and signals through an input/output region IO shared by the memory banks included in the pair. Accordingly, among the first to sixteenth memory banks BK0(1)-BK0(16) connected to the first channel CH0, eight memory banks selected by a bank address may be accessed simultaneously through the first to eighth input/output regions IO1-IO8. Similarly, among the memory banks BK1(1)-BK1(16) connected to the second channel CH1, eight memory banks selected by a bank address may be accessed at the same time through the input/output regions IO1-IO8. Likewise, among the memory banks BK2(1)-BK2(16) connected to the third channel CH2, eight memory banks selected by a bank address may be simultaneously accessed through the input/output regions 101-IO8. Likewise, among the memory banks BK3(1)-BK3(16) connected to the fourth channel CH3, eight memory banks selected by a bank address may be accessed at once through the input/output regions IO1-IO8.

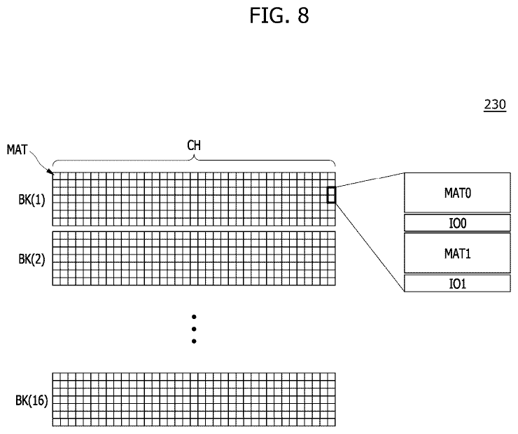

FIG. 8 is a diagram illustrating another example configuration of a memory die included in the PIM device according to the present disclosure.

Referring to FIG. 8, a memory die 230 includes a plurality of memory banks coupled to a channel, for example, first to sixteenth memory banks BK(1)-BK(16). Although not explicitly shown in the figure, the memory die 230 may include a plurality of channels, each of which may be coupled to a plurality of memory banks, similar to the configurations described with reference to FIGS. 6 and 7.

Each of the memory banks may include a plurality of mats MATs. Each of the mats MATs may have a cell array structure and may be coupled to an input/output region disposed beneath the mat. As shown on the right side of FIG. 8, one of the mats included in the first memory bank BK(1), such as a first mat MAT0, may transmit or receive data and signals through a first input/output region 100 that is disposed adjacent to the first mat MAT0. Similarly, a second mat, MAT1, included in the first memory bank BK(1), may input or output data and signals via a second input/output region IO1 disposed adjacent to the second MAT1.

In one embodiment, each of the mats MATs constituting the memory bank BK may include a sense amplifier circuit. The sense amplifier circuit may be disposed above the input/output region IO such that the sense amplifier circuit overlaps with the input/output region IO. For example, a sense amplifier circuit included in the first mat MAT0 may be disposed above the first input/output region 100 in an overlapping manner. Similarly, a sense amplifier circuit included in the second mat MAT1 may be disposed above the second input/output region IO1.

The memory die 230 according to this example is configured such that the mats MATs constituting each memory bank BK may perform input/output operations in parallel. Accordingly, the memory die 230 may provide a greater internal bandwidth than the memory die 220 described with reference to FIG. 7. That is, by increasing the data transfer rate to the processing unit die 100 of FIG. 1, the computation speed of the processing unit die 100 can be further improved.

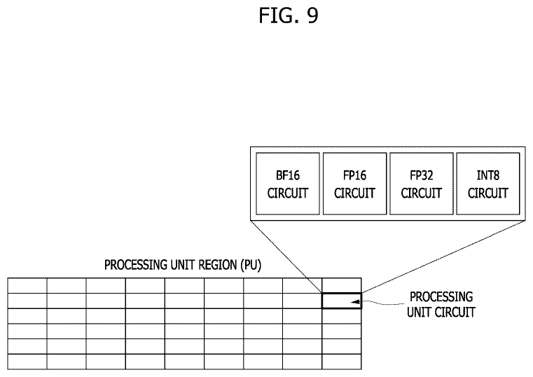

FIG. 9 is a diagram illustrating an example configuration of a processing unit region of a processing unit die included in the PIM device according to the present disclosure.

Referring to FIG. 9, a processing unit region PU includes a plurality of processing unit circuits. In one embodiment, the plurality of processing unit circuits may include at least one of a multiply-accumulate (MAC) circuit, an arithmetic logic unit (ALU), a floating point unit (FPU), an integer arithmetic circuit, an activation function circuit, a data format conversion circuit, a vector processing unit, and a local memory.

The MAC circuit may perform matrix multiplication or convolution operations used in deep learning. The ALU may perform arithmetic and logic operations such as addition, subtraction, AND, OR, and XOR. The FPU and the integer arithmetic circuit may perform floating-point and integer operations, respectively. The activation function circuit may execute nonlinear functions such as ReLU, Sigmoid, and Tanh. Typically, an activation function circuit performs operations using a look-up table and interpolation. However, in the present example, because the processing unit die and the memory die are separately disposed, the activation function operations can be computed arithmetically, which may improve computation accuracy.

The plurality of processing unit circuits may perform operations using data provided from the memory die 100 of FIG. 1. The processing unit circuits may transmit the operation result data, generated as a result of the computation, to an external device of the PIM device 10 of FIG. 1 via the wires 400. At least one of the plurality of processing unit circuits may be configured to support multi-precision operations. For example, as shown in the enlarged view in FIG. 9, a processing unit circuit may include a BF16 circuit, an FP16 circuit, an FP32 circuit, and an INT8 circuit.

The BF16 circuit is configured to perform operations on data in the BFloat16 (brain floating point 16-bit) format. The BF16 circuit is typically used in AI training and inference and may reduce computation load while maintaining similar accuracy compared to the FP32 circuit. The FP16 circuit is configured to operate on data in the 16-bit half-precision floating-point format and may be used primarily in GPU-based deep learning acceleration. The FP32 circuit is configured for operations on data in the 32-bit single-precision floating-point format and may be used for computations requiring high accuracy. The INT8 circuit is configured to operate on 8-bit integer data and may be used for deep learning inference, significantly reducing power consumption and computation cost.

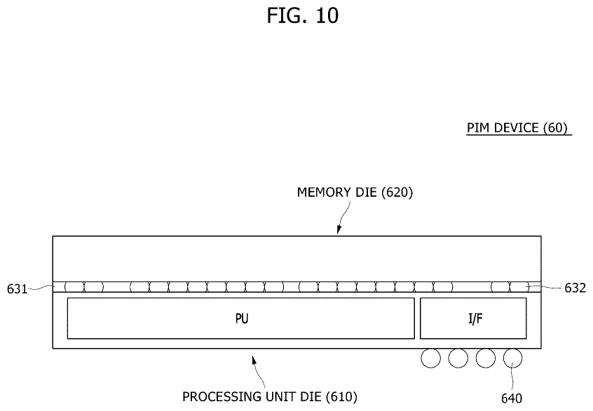

FIG. 10 is a cross-sectional view illustrating another example of a processing-in-memory (PIM) device according to the present disclosure.

Referring to FIG. 10, a PIM device 60 includes a processing unit die 610 and a memory die 620. The processing unit die 610 and the memory die 620 are bonded together via wafer-to-wafer hybrid bonding. The wafer-to-wafer hybrid bonding may be performed by aligning and bonding a first wafer including the processing unit dies 610 and a second wafer including the memory dies 620.

More specifically, the first and second wafers are aligned such that oxide layers and metals are exposed. Subsequently, the wafers are aligned with sub-micron precision so that the oxide layers of the first and second wafers are bonded by Van der Waals forces and hydrogen bonding. Thereafter, an annealing process is performed to increase the bonding strength of the oxide layers and to bond the metals of the first and second wafers through metal diffusion. Through this wafer-to-wafer hybrid bonding, the processing unit die 610 and the memory die 620 of the PIM device 60 are bonded together via an oxide bonding layer 631 and a metal diffusion bonding layer 632.

The processing unit die 610 includes a processing unit region PU and an interface region I/F. The processing unit die 610 may further include a test region as described with reference to FIG. 2. The description of the processing unit region PU in FIG. 9 is equally applicable to the processing unit region PU in the processing unit die 610. Accordingly, the processing unit region PU may include a plurality of processing unit circuits.

The interface region I/F included in the processing unit die 610 may be disposed to be adjacent to one side of the processing unit region PU. A plurality of bumps 640 may be disposed on a lower surface of the processing unit die 610 to overlap with the interface region I/F. The processing unit die 610 may communicate with external devices of the PIM device 60, such as a controller or host, via the bumps 640. A plurality of interface circuits may be disposed in the interface region I/F. In one embodiment, the interface circuits may include a command/address decoder, a physical layer circuit, a serializer/deserializer (SerDes) circuit, a protocol controller, buffer and queue management circuits, voltage level shifters, clock domain crossing (CDC) circuits, and error detection and correction circuits.

The interface region I/F may further include a plurality of through-silicon vias (TSVs) that electrically connect the bumps 640 disposed below the processing unit die 610 with the metal diffusion bonding layer 632 disposed between the processing unit die 610 and the memory die 620.

The memory die 620 may be configured similarly to the memory die 220 described with reference to FIG. 7 or the memory die 230 described with reference to FIG. 8. When configured similarly to the memory die 220 of FIG. 7, the first through eighth input/output regions IO1 to IO8 may be connected to the processing unit die 610 through the oxide bonding layer 631 and the metal diffusion bonding layer 632. When configured similarly to the memory die 230 of FIG. 8, a plurality of input/output regions of the memory die 230 may also be connected to the processing unit die 610 through the oxide bonding layer 631 and the metal diffusion bonding layer 632. The memory die 620 may provide operand data used in computation to the processing unit die 610 via the metal diffusion bonding layer 632.

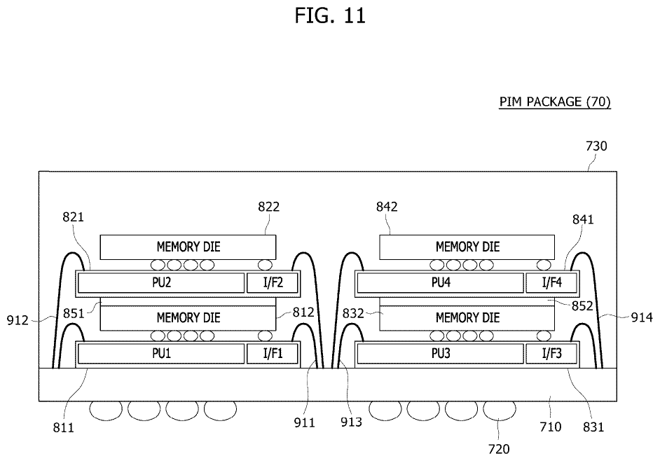

FIG. 11 is a cross-sectional view illustrating an example of a PIM package according to the present disclosure. In the following description, it is assumed that the PIM package includes PIM devices each having four channels.

Referring to FIG. 11, a PIM package 70 includes first through fourth PIM devices disposed on a package substrate 710. The package substrate 710 includes a plurality of solder balls 720 on bottom surface of the package substrate 710. Although not shown in the figure, the package substrate 710 may include a multilayer wiring structure. The first through fourth PIM devices may be encapsulated in a molding compound 730.

The first PIM device includes a first processing unit die 811 and a first memory die 812. The second PIM device includes a second processing unit die 821 and a second memory die 822. The third PIM device includes a third processing unit die 831 and a third memory die 832. The fourth PIM device includes a fourth processing unit die 841 and a fourth memory die 842. The respective processing unit dies 811, 821, 831, and 841 and memory dies 812, 822, 832, and 842 are electrically interconnected via micro bumps.

The first processing unit die 811 is disposed on a first upper surface of the package substrate 710. The second processing unit die 821 is disposed on an upper surface of the first memory die 812. A lower surface of the second processing unit die 821 is bonded to the upper surface of the first memory die 812 via a first adhesive layer 851. Accordingly, the first and second PIM devices are vertically stacked over the first upper surface of the package substrate 710.

The third processing unit die 831 is disposed on a second upper surface of the package substrate 710. The fourth processing unit die 841 is disposed on an upper surface of the third memory die 832. A lower surface of the fourth processing unit die 841 is bonded to the upper surface of the third memory die 832 via a second adhesive layer 852. Accordingly, the third and fourth PIM devices are vertically stacked over the second upper surface of the package substrate 710.

The first processing unit die 811 includes a first processing unit region PU1 and a first interface region I/F1. The second processing unit die 821 includes a second processing unit region PU2 and a second interface region I/F2. The third processing unit die 831 includes a third processing unit region PU3 and a third interface region I/F3. The fourth processing unit die 841 includes a fourth processing unit region PU4 and a fourth interface region I/F4. The descriptions of the processing unit region 110 in FIG. 2 and the processing unit region PU in FIG. 9 are equally applicable to the processing unit regions PU1 to PU4.

The first processing unit die 811 is electrically connected to the package substrate 710 via a first wire 911. The signal and data transmission path between the first processing unit die 811 and the package substrate 710 via the first wire 911 constitutes a first channel. Similarly, the second processing unit die 821 is electrically connected to the package substrate 710 via a second wire 912, forming a second channel. The third processing unit die 831 is electrically connected to the package substrate 710 via a third wire 913, forming a third channel. The fourth processing unit die 841 is electrically connected to the package substrate 710 via a fourth wire 914, forming a fourth channel.

The first to fourth memory dies 812-842 may be configured in the same manner as the memory die 200 described with reference to FIG. 1. The description of the memory die 210 in FIG. 6 and the memory die 220 in FIG. 7 is equally applicable to the memory dies 812 to 842.

In the first PIM device, the external bandwidth provided by the first wires 911 between the first processing unit die 811 and the package substrate 710 is relatively greater than the internal bandwidth provided by the micro bumps between the first processing unit die 811 and the first memory die 812. In the second PIM device, the external bandwidth via the second wires 912 is greater than the internal bandwidth between the second processing unit die 821 and the second memory die 822. Similarly, in the third and fourth PIM devices, the external bandwidths via the third and fourth wires 913 and 914 are greater than the respective internal bandwidths between the third processing unit die 831 and the third memory die 832 and between the fourth processing unit die 841 and the fourth memory die 842.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A processing-in-memory (PIM) device comprising:
a processing unit die configured to communicate with an external device with an external bandwidth; and
a memory die configured to communicate with the processing unit die with an internal bandwidth,
wherein the external bandwidth and the internal bandwidth are asymmetrically configured to operate at different data transfer rates.

2. The PIM device of claim 1, wherein the internal bandwidth is relatively greater than the external bandwidth.

3. The PIM device of claim 1, wherein the processing unit die is electrically coupled to the external device via a wire having the external bandwidth.

4. The PIM device of claim 1, further comprising a plurality of micro bumps configured to electrically connect the processing unit die and the memory die and to provide the internal bandwidth.

5. The PIM device of claim 1, wherein the processing unit die comprises:
a processing unit region in which processing unit circuits are disposed;
an input/output region in which micro bumps are disposed; and
an interface region in which interface circuits are disposed.

6. The PIM device of claim 5, wherein the processing unit region is disposed in a central region of the processing unit die,
wherein the input/output region is disposed over the processing unit region so as to partially overlap the processing unit region, and
wherein the interface region is disposed adjacent to one side of the processing unit region.

7. The PIM device of claim 5, wherein at least one of the plurality of processing unit circuits is configured to support multi-precision.

8. The PIM device of claim 7, wherein at least one of the processing unit circuits comprises at least one of a BF16 circuit, an FP16 circuit, an FP32 circuit, and an INT8 circuit,
wherein the BF16 circuit is configured to perform operations on data in BFloat16 format,
wherein the FP16 circuit is configured to perform operations on data in 16-bit half-precision floating point format,
wherein the FP32 circuit is configured to perform operations on data in 32-bit single-precision format, and
wherein the INT8 circuit is configured to perform operations on data in 8-bit integer format.

9. The PIM device of claim 5, wherein the processing unit die further comprises:
a plurality of pads disposed on an edge of a surface of the processing unit die; and
wires configured to electrically couple the pads to the external device.

10. The PIM device of claim 9, wherein each of the processing unit circuits comprises a plurality of arithmetic circuits disposed in the processing unit region,
wherein the plurality of arithmetic circuits comprise:
a MAC (multiply-and-accumulate) circuit configured to perform MAC operations;
a register circuit configured to store operand data;
a control circuit configured to control the MAC circuit and the register circuit; and
a plurality of interconnections for signal transmission.

11. The PIM device of claim 10, wherein the plurality of interconnections comprises:
data input/output lines coupled to the micro bumps disposed in the input/output region; and
signal transmission lines coupled to a group of wires through the interface region.

12. The PIM device of claim 10, wherein each of the processing unit circuits further comprises an activation function circuit configured to perform nonlinear function operations arithmetically.

13. The PIM device of claim 5, wherein the processing unit die further comprises a test region in which test circuits are disposed,
wherein the test circuits include at least one of a built-in self-test (BIST) circuit, a scan chain circuit, a boundary scan (JTAG) circuit, a design-for-test (DFT) control circuit, a built-in current sensor (BICS), and a delay fault detection circuit.

14. The PIM device of claim 13, wherein the processing unit die further comprises:
a plurality of pads disposed on an edge of a surface of the processing unit die; and
wires electrically connecting the pads to the external device,
wherein the pads comprise first pads disposed to be adjacent to the interface region and second pads disposed to be adjacent to the test region, and
wherein the second pads include direct access (DA) pads configured to directly access the memory die through the input/output region without passing through the interface region.

15. The PIM device of claim 14, wherein the processing unit die further comprises signal selection logic including a first AND gate, a second AND gate, and a multiplexer,
wherein the signal selection logic is configured such that:
in response to a first control signal at a first logic level and a second control signal at a second logic level complementary to the first logic level, a signal transmitted through the first pads is transferred to the memory die via the multiplexer, and
in response to the first control signal at the second logic level and the second control signal at the first logic level, a signal transmitted through the second pads is transferred to the memory die via the multiplexer.

16. The PIM device of claim 15, wherein the first AND gate includes:
a first input terminal receiving the first control signal,
a second input terminal coupled to an output terminal of the multiplexer, and
an output terminal connected to wiring between the first pads and a first input terminal of the multiplexer;
wherein the second AND gate includes:
a first input terminal receiving the second control signal,
a second input terminal coupled to the output terminal of the multiplexer, and
an output terminal connected to wiring between the second pads and a second input terminal of the multiplexer; and
wherein the multiplexer includes:
a first input terminal coupled to the first pads and the output terminal of the first AND gate,
a second input terminal coupled to the second pads and the output terminal of the second AND gate, and
an output terminal coupled to the memory die.

17. The PIM device of claim 1, wherein the processing unit die is electrically coupled to the external device via a wire having the external bandwidth, and is electrically coupled to the memory die via micro bumps having the internal bandwidth,
wherein the memory die includes a plurality of memory banks coupled to a channel and an input/output region,
wherein the input/output region is coupled to the micro bumps, and
wherein the plurality of memory banks are divided into a first group and a second group, the first group and the second group being configured to share the input/output region.

18. The PIM device of claim 1, wherein the processing unit die is electrically coupled to the external device via a wire having the external bandwidth and is electrically coupled to the memory die via micro bumps having the internal bandwidth,
wherein the memory die includes a plurality of memory banks coupled to a channel and a plurality of input/output regions,
wherein each pair of two memory banks forms a memory bank pair, and
wherein each memory bank pair is configured to share one of the plurality of input/output regions.

19. The PIM device of claim 1, wherein the processing unit die is electrically coupled to the external device via a wire having the external bandwidth and is electrically coupled to the memory die via micro bumps having the internal bandwidth,
wherein the memory die includes a plurality of memory banks coupled to a channel and a plurality of input/output regions,
wherein each of the plurality of memory banks includes a plurality of mats, and
wherein the plurality of mats are configured to be coupled respectively to the plurality of input/output regions.

20. The PIM device of claim 1,
wherein the processing unit die and the memory die are bonded together through wafer-to-wafer hybrid bonding.

21. A processing-in-memory (PIM) package comprising:
a package substrate;
at least one PIM device disposed on the package substrate; and
a molding compound covering the at least one PIM device on the package substrate,
wherein the at least one PIM device comprises:
a processing unit die configured to communicate with an external device with an external bandwidth; and
a memory die configured to communicate with the processing unit die with an internal bandwidth,
wherein the external bandwidth and the internal bandwidth are asymmetrically configured to operate at different data transfer rates.
